(19) United States
(12) Patent Application Publication
(10) Pub. No.: US 2005/0030271 A1
(43) Pub. Date: Feb. 10, 2005

(54) Gray level correction device for LCD

(76) Inventor: Hong-Da Liu, Chu Pei City (TW)

Correspondence Address: RABIN & BERDO, P.C., 1101 14 Street, N.W., Suite 500, Washington, DC, 20005, US

(21) Appl. No.: 10/785,192

(22) Filed: Feb. 25, 2004

(30) Foreign Application Priority Data
Aug. 8, 2003 (TW) 92121919

(51) Int. Cl. G09G 3/36

(52) U.S. Cl. 345/89

(57) ABSTRACT

A gray level correction device for a liquid crystal display is disclosed for applications in transflective liquid crystal displays. When the display image is switched between a transitive type and a reflective type, or the conditions of the external light source changes, the γ curve of the display is switched by a γ-curve correction device. Multi-mode γ curves are designed according to the variation of the source light. By comparing with a built-in database, the γ curve is switched to adjust the gray level to an optimized value, thereby obtaining the best display image in the transitive type and reflective type or the contrast in different environments.

### BACKGROUND OF THE INVENTION

1. Field of Invention

The invention relates to a planar display device and, in particular, to a transflective liquid crystal display (LCD) that can be used under different environmental light sources.

2. Related Art

For a long time, LCD has been widely used in digital electronic products such as electronic watches and calculators. With further developments and advances in thin-film transistor (TFT) LCD and their advantages of having small sizes, light weights, low driving voltages, and low power consumption, they have been used in laptop computers, personal digital processing systems, and color televisions. They are gradually replacing conventional large-size cathode ray tube (CRT) displays.

The development of LCD first starts with the transitive type. The light source of a normal transitive type LCD is built on the back of the display, called the back light. Therefore, its pixel electrode has to use a transparent conductive material, such as indium tin oxide (ITO). Since the back light source used in the transitive LCD consumes a lot of electrical energy, its development is greatly limited.

The reflective LCD is thus invented. It uses external natural light or artificial light as the light source. Therefore, it has to use a reflective layer to reflect the external light. Traditionally, one often uses the pixel electrode as the reflective layer. However, there is still one problem. That is, when the external light is not bright enough, the reflective LCD cannot clearly display the images. Therefore, the half-transitive, half-reflective LCD, or simply called the transflective LCD, has become the next objective in LCD development. In a transflective LCD, one or several openings are formed in the central part of the pixel electrode made of aluminum. The openings are then filled with ITO. Consequently, when the external light is not bright enough, the back light can be turned on to provide light.

For either type of LCD, when the user views the LCD panel from different positions, the transitive or reflective property of light also changes. For example, the position vertical to the LCD screen has the best transitive and reflective rates. If the user views the screen at an angle, different optical presentation will be observed. Generally speaking, the transitive rate and the reflective rate are functions of the imposed voltage. They are defined as the T-V curve and the R-V curve in the γ curves, respectively. The conventional LCD only uses the vertical viewing angle to calibrate the γ curves. This method renders the γ curves constant values, not the optimized values. In particular, the light source of the reflective or transflective LCD is not stable. The environmental light may change at any time. Consequently, the LCD screen cannot reach the optimal display effect.

For transflective LCD, the T-V curve and the R-V curves are not exactly the same under same operating conditions. Therefore, the gray levels of the transitive image and the reflective image are often different, resulting in image quality deterioration. How to reconcile the good optical properties of both transitive and reflective type LCD so that the transflective LCD can switch the γ curves to the optimal state as the back light switches.

### SUMMARY OF THE INVENTION

An objective of the invention is to provide an LCD that has a gray level adjuster of the transflective LCD. According to the changes in environmental light, different viewing angles, or the different strengths in front and back light sources, multi-mode γ curves are designed so as to switch the γ curves to their optimal values.

Another objective of the invention is to provide a gray level adjuster for the transflective LCD, which can reconcile between the gray level presentations of both transitive and reflective light. When an image is switched between the transitive type and the reflective type, a best image quality can be obtained.

From one viewpoint, the invention provides a gray level correction device to adjust the γ-curve signal of a transflective LCD. The device contains at least a sensor. Explicitly, a first sensor detects an external light projecting onto the LCD, including the intensities from various different angles, and produces a first light source signal. A second sensor detects the light intensity of the back light source, or even that of the front light source, and produces a second light source signal. The light intensity of the back light or the front light can be set by a circuit system into a built-in database. The built-in database contains the γ curves of the external light, the front light, and the back light. From the first and second light source signals detected by the first and second sensors, an adjusting signal is output to the γ-curve adjusting device. Through the corrections by the γ-curve adjusting device, the corrected γ-curve signal is output to the LCD panel in order to present ideal display images.

The invention finds an optimized γ-curve correction parameter by comparing with a γ-curve database and produces a signal to be sent to the γ-curve adjusting device. Even if the intensity of external light or back light changes, the γ-curve adjusting device can still balance the gray levels of the reflective and transitive light, rendering an optimal display quality on the LCD panel.

### BRIEF DESCRIPTION OF THE DRAWINGS

These and other features, aspects and advantages of the invention will become apparent by reference to the following description and accompanying drawings which are given by way of illustration only, and thus are not limitative of the invention, and wherein:

FIG. 1 is a plot showing the R-V curve and the T-V curve under the same conditions;

FIGS. 2a to 2c depict incident beams and reflective beams of different angles and the corresponding receiving positions;

FIG. 3 shows the R-V curves for FIGS. 2a to 2c;

FIG. 4 is a schematic view of the structure in the disclosed gray level correction device;

FIG. 5 shows the γ-curve database generated for different viewing angles, environmental light intensities, and temperatures;

FIG. 6 is a schematic view of the gray level correction device according to a preferred embodiment of the invention;

FIG. 7 is a schematic view of the arrangement sensors according to the invention; and

FIG. 8 is a schematic view of the γ-curve correction device according to a preferred embodiment of the invention.

### DETAILED DESCRIPTION OF THE PREFERRED EMBODIMENT

The present invention will be apparent from the following detailed description, which proceeds with reference to the accompanying drawings, wherein the same references relate to the same elements.

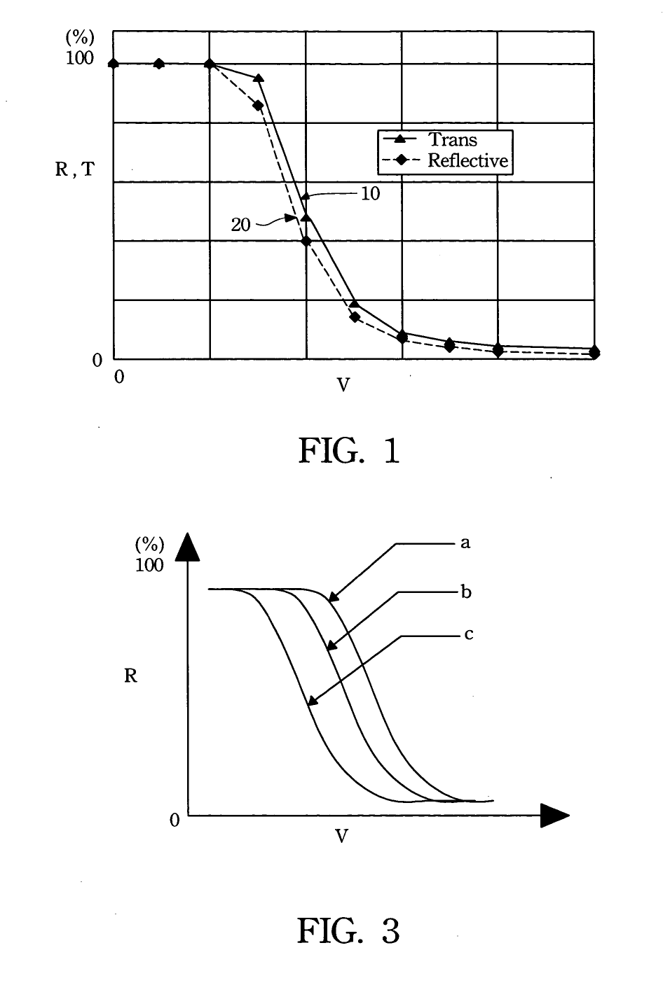

The optical performance of a transflective LCD in response to electrical signals is generally represented by γ curves. In the γ curves, transparent properties have great influence on the gray level of an image. With reference to FIG. 1, under fixed operation conditions, the transitive image has different transitive rates for different voltages, represented by the T-V curve 10. Likewise, under the same operation conditions, the reflective image also has different reflective rates for different voltages, represented by the R-V curve 20. Usually, the reflective rate is different from the transitive rate even under the same voltage. The different transitive rate and reflective rate will result in different gray levels for the transitive image and the reflective image, affecting the image quality. This phenomenon has great effects on the images on a transflective LCD.

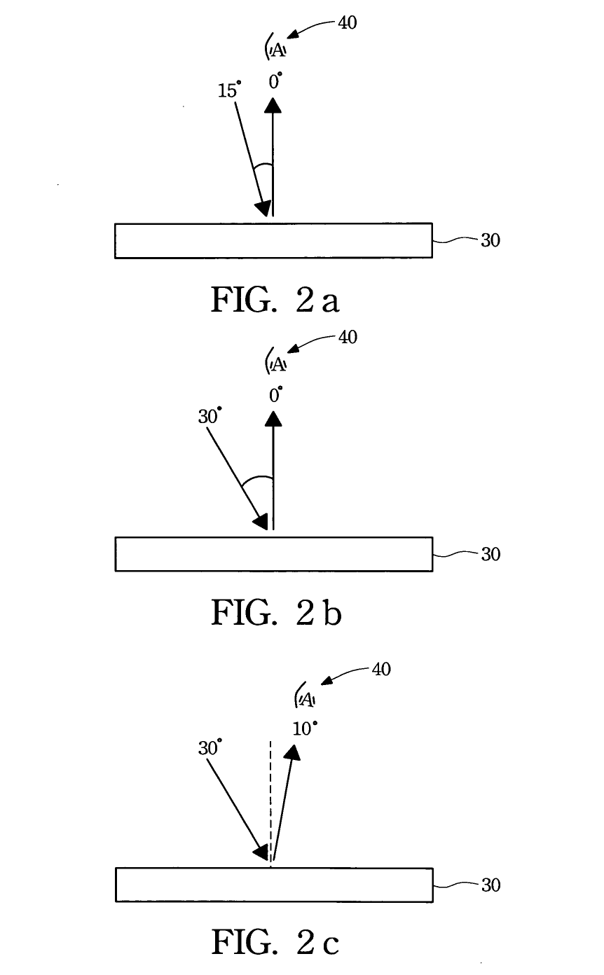

Besides, there are different R-V curves for reflective light source because of different incident angles and viewing angles. FIGS. 2a-2c depict incident beams of different angles, corresponding to receiving users at different positions. As shown in FIG. 2a, when the incident beam has a 15-degree incident angle relative to the display panel 30 and the user 40 views the image from the direction perpendicular to the display panel 30, the result is represented by one R-V curve. As shown in FIG. 2b, when the incident beam has a 30-degree incident angle relative to the display panel 30 and the user 40 views the image from the direction perpendicular to the display panel 30, the result is represented by another R-V curve. When the incident beam has a 30-degree incident angle relative to the display panel 30 and the user 40 views the image at an angle of 10 degrees relative to the display panel 30, the result is represented by yet another R-V curve, as shown in FIG. 2c. If one normalizes and stacks the above three R-V curves for comparison, as shown in FIG. 3, the changes in both the incident angle and user's viewing position will affect the image quality. In FIG. 3, curves a, b, and c are the R-V curves in FIGS. 2a, 2b, and 2c, respectively.

The invention provides a gray level correction device of the LCD. A sensor is installed near the shell of the display panel for detecting the variation of the environmental light. A sensor or built-in circuit control system is simultaneously provided inside the display panel to detect the variation of front light or backlight of the display panel. According to possible light source variations, the γ curves are designed to have multi-modes. A built-in database is used to switch the γ curves of the transitive and reflective light to an optimal value by comparing with the light source variation. Consequently, the gray levels of the reflective and transitive types of light can be reconciled to present a best image on the display panel.

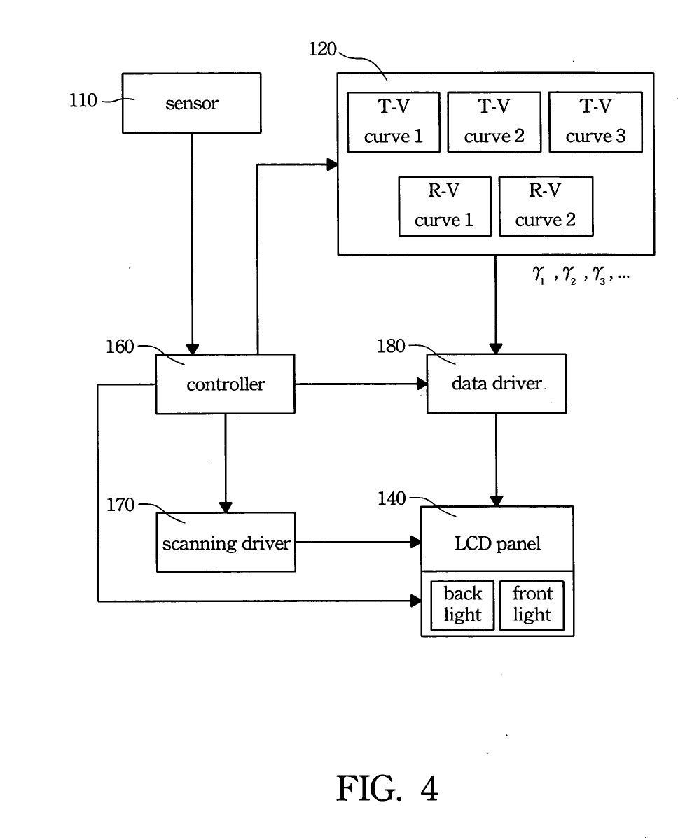

As shown in FIG. 4, a sensor 110 is used to detect the intensity of a light source and sends the light source signal to a controller 160. The controller 160 has memory and relevant database to store the light source signal. The data stored in the controller 160 can be transmitted to a γ-curve database 120 for obtaining a γ curve, or controlling the operations of a data driver 180, a scanning driver 170, and a LCD panel 140. The γ curves from the γ-curve database 120 are processed by the data driver 180 to control the display state of the LCD panel 140. The scanning driver 170 also processes the scanning method of the LCD panel 140 via the controller 160.

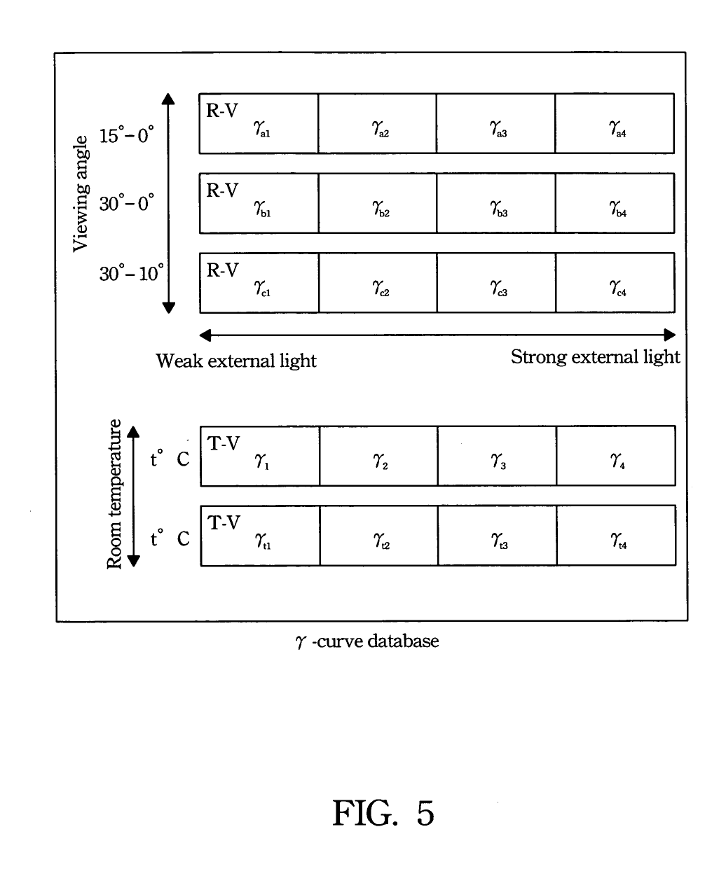

FIG. 5 shows the detailed view of the γ-curve database 120 generated according to different viewing angles, light intensities, and temperatures. In the drawing, the γ curve for the reflective rate versus voltage curve changes as the viewing angle varies. For example, the viewing angles for the γₐₙ curve fall in the range 15°-0°, and those for the γ_{cn} curve fall in the range of 30°-10°, where n=1, 2, 3, 4 . . . The γ curve for the transitive rate versus voltage curve changes with temperature. For example, the γₙ curve is for room temperature, and the γₜₙ curves are for a temperature of t°C °, where n=1, 2, 3, 4 . . . Moreover, as shown in FIG. 5, changes in the intensity of environmental light also affect the γ curves.

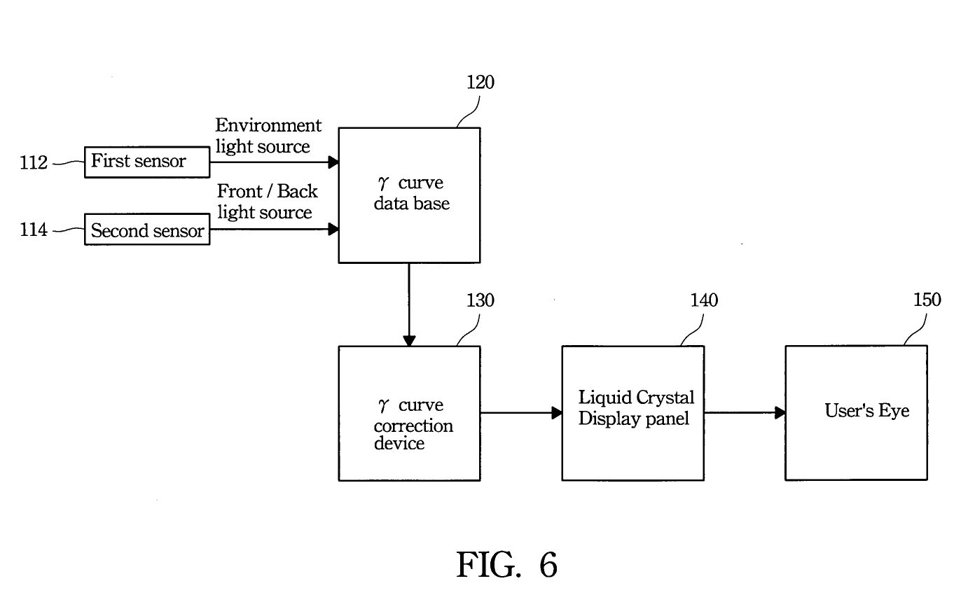

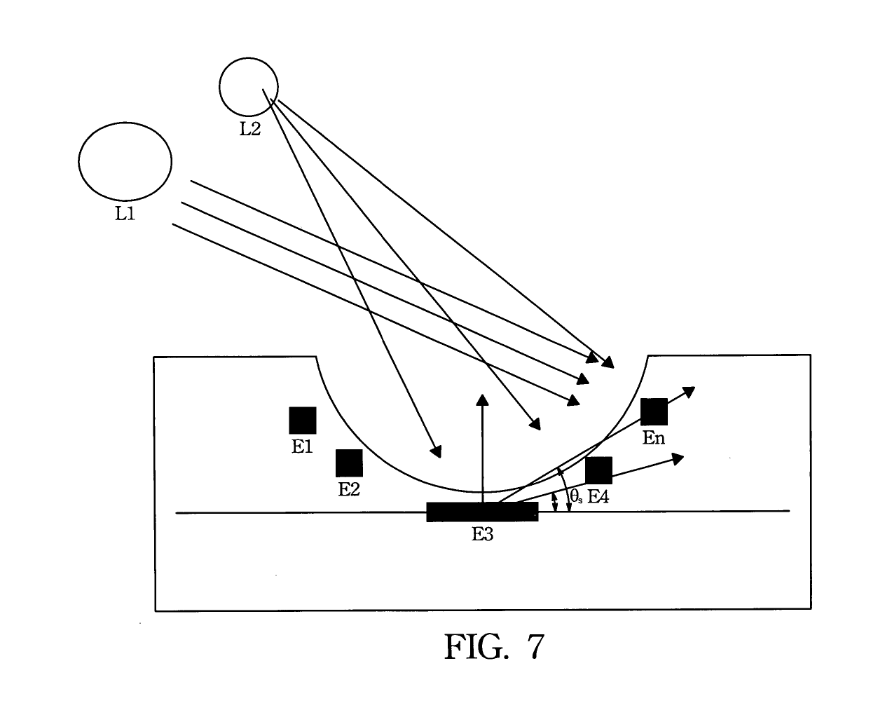

According to a preferred embodiment of the invention, the gray level correction device includes two sensors 112, 114, as shown in FIG. 6. The first sensor 112 is installed near the shell of the display panel for detecting the environmental light incident on the display panel. The first sensor 112 can be composed of several optical sensors, such as the charge coupled devices (CCD) or the complementary metal oxide semiconductor (CMOS) device for optical detection. FIG. 7 shows the arrangement of the first sensor 112. The first sensor 112 is disposed on the concave arc part of the panel (represented by E1, E2, E3, E4, and En). This arc shape can be a semi-circle, a semi-ellipse, or part of an ellipse. The angle between the sensor and the display panel θs is preferably in the range of 15°˜65°. The first sensor 112 can detect the brightness of the light sources L1 and L2 with different incident angles toward the display panel, thereby detecting the variation of environmental light.

With further reference to FIG. 6, the second sensor 114 is installed inside the display panel. It is mainly used to detect the intensity of a back light source. If a front light source is used, the second sensor 114 also detects its intensity. The second sensor 114 can also be made of CCD or CMOS devices. One may use a built-in circuit system inside the display panel for control and detection. The first sensor 112 and the second sensor 114 can detect the intensities of environmental light coming from different angles and those of the front light and back light sources. The detected data are transmitted to the γ-curve adjusting device 130.

A γ-curve database 120 is installed inside the LCD (as shown in FIGS. 5 and 6). The database 120 contains the γ curves of all kinds of conditions. It contains at least the R-V curves formed from different intensities and angles of external light, the T-V curves formed from different intensities of front light or back light, and different γ curves presented at different viewing angles and under different temperatures. Therefore, the database 120 contains the combinations of all the above conditions. When the sensors 112, 114 send detected data as the input conditions to the γ-curve database 120, an appropriate γ curve is found and output to a γ-curve adjusting device 130. The γ-curve adjusting device 130 tunes the γ curve to an optimal one according to the given conditions and outputs the results to the LCD panel 140. Therefore, the LCD panel 140 can present a best image to the user's eye. In a preferred embodiment, a better image quality can be obtained for angles subtended by the user and the incident beam between 5° and 65°. A preferred range is 15°˜40°

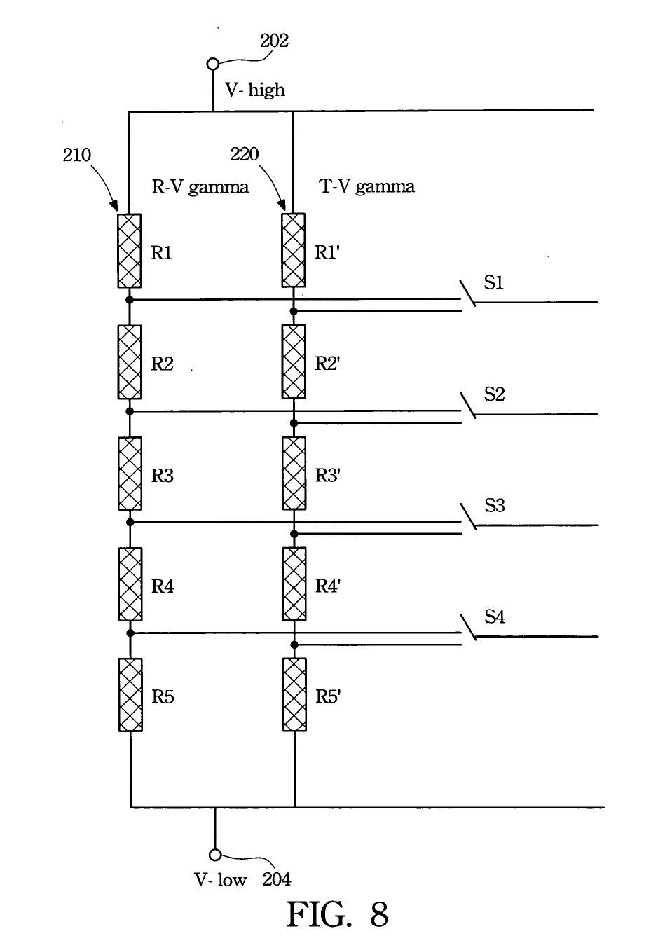

The γ-curve adjusting device 130 usually uses a control circuit to adjust the γ curves. The following embodiment uses the 0-degree viewing angle to explain the invention. As shown in FIG. 8, a reflectivity control resistor series 210, comprising several reflectivity control resistors R1, R2, R3, R4, and R5 connected in series, is used in the γ-curve adjusting device 130 to adjust the R-V γ curve. Likewise, a transitivity control resistor series 220, comprising several transitivity control resistors R1′, R2′, R3′, R4′, and R5′ connected in series, is used in the γ-curve adjusting device 130 to adjust the T-V γ curve. The reflectivity control resistor series 210 and the transitivity control resistor series 220 are connected in parallel between two circuit end points 202, 204. In the reflectivity control resistor series 210, each node between two adjacent resistors (such as R1 and R2) is connected to a corresponding switcher (such as S1). Likewise, in the transitivity control resistor series 220, each node between two adjacent resistors (such as R1′ and R2′) is connected to a corresponding switcher (such as S1).

When adjusting the R-V and T-V γ curves, different high-low voltages are imposed at the end points 202, 204, generating a potential difference. Switchers S1, S2, S3, and S4 are used to make switches, tuning the γ curves to their optimal values. For adjusting several viewing angles, of course, other sets of reflectivity control resistor series and transitivity control resistor series can be connected in parallel for tuning.

In summary, the invention provides a gray level correction device for transflective LCD's. It detects the changes in the intensities of environmental light, front light, and back light and the user's viewing angle at all time. The γ curves of the LCD are tuned according to the built-in database in order to reconcile between the gray levels of transitive and reflective light. The quality of displayed images will not deteriorate because of changes in light intensities. Thus, the LCD can present satisfactory images in any kind of environments.

While the invention has been described by way of example and in terms of the preferred embodiment, it is to be understood that the invention is not limited to the disclosed embodiments. To the contrary, it is intended to cover various modifications and similar arrangements as would be apparent to those skilled in the art. Therefore, the scope of the appended claims should be accorded the broadest interpretation so as to encompass all such modifications and similar arrangements.

1. A gray level correction device for tuning a γ-curve signal of a liquid crystal display (LCD), the gray level correction device comprising:
a first sensor, which detects an external light source projecting to the LCD, including intensities of light at a plurality of angles, and converts the intensities into a first light source signal;
a second sensor, which detects the light intensity of a back light source of the LCD and converts the light intensity into a second light source signal;
a database, which receives the first and second light source signals, is built with the γ curves of the external light source and the back light source, and outputs a correction signal according to the first and second light source signals;
a γ-curve correction device, which receives the correction signal and outputs a γ-curve signal according to the correction signal; and
a liquid crystal display (LCD) panel, which receives the γ-curve signal and displays an image accordingly.

2. The device of claim 1, wherein the LCD is a transflective LCD.

3. The device of claim 1, wherein the first sensor is installed on the shell of the LCD panel.

4. The device of claim 1, wherein the first sensor includes a plurality of optical sensors.

5. The device of claim 1, wherein the second sensor further detects a front light source.

6. The device of claim 1, wherein the second sensor includes a plurality of optical sensors.

7. The device of claim 1, wherein the γ curve of the external light source includes an R-V (reflective rate versus voltage) curve.

8. The device of claim 1, wherein a preferred angle between the external light source and the user is between 5° and 65°.

9. The device of claim 1, wherein a preferred angle between the external light source and the user is between 15° and 40°.

10. The device of claim 1, wherein the γ curve of the back light source includes a T-V (transitive rate versus voltage) curve.

11. The device of claim 1, wherein the γ-curve correction device includes a reflective control resistor series and a transitive control resistor series connected in parallel.

12. The device of claim 11, wherein the reflective control resistor series and the transitive control resistor series comprise a plurality of serially connected resistors.

13. A gray level correction device for tuning a γ-curve signal of a liquid crystal display (LCD), the gray level correction device comprising:
a first sensor, which detects an external light source projecting to the LCD, including intensities of light at a plurality of angles, and converts the intensities into a first light source signal;
a second sensor, which detects the light intensity of a back light source of the LCD and converts the light intensity into a second light source signal;
a database, which receives the first and second light source signals, is built with the γ curves of the external light source and the back light source, and outputs a correction signal according to the first and second light source signals; and
a γ-curve correction device, which receives the correction signal and outputs a γ-curve signal according to the correction signal.

14. The device of claim 13, wherein the LCD is a transflective LCD.

15. The device of claim 13, wherein the first sensor is installed on a concave arc structure on the LCD panel and comprises a plurality of the first sensors.

16. The device of claim 13, wherein the second sensor further detects a front light source and comprises a plurality of the second sensors.

17. The device of claim 13, wherein the γ curve of the external light source includes an R-V (reflective rate versus voltage) curve.

18. The device of claim 13, wherein a preferred angle between the external light source and the user is between 5° and 65°.

19. The device of claim 13, wherein a preferred angle between the external light source and the user is between 15° and 40°.

20. The device of claim 13, wherein the γ curve of the back light source includes a T-V (transitive rate versus voltage) curve.
